(19) United States
(12) Patent Application Publication
(10) Pub. No.: US 2009/0183780 A1
(43) Pub. Date: Jul. 23, 2009

(54) Water trap assembly for vacuum-line plumbing systems

(76) Inventor: John Tiwet, Waukegan, IL (US)

Correspondence Address: John Tiwet, 4463 W. Lawn Avenue, Waukegan, IL, 60085, US

(21) Appl. No.: 12/009,470

(22) Filed: Jan. 18, 2008

(51) Int. Cl. F16K 31/18

(52) U.S. Cl. 137/203

(57) ABSTRACT

A water trap shut-off assembly wherein accumulated water inside the canister is capable of lifting a float. The float is adapted to achieve a sealing interface with a seal gasket, thereby interrupting fluid flow in a fluid passageway therethrough.

### CROSS-REFERENCE TO RELATED APPLICATIONS

Not applicable

### STATEMENT REGARDING FEDERALLY SPONSORED RESEARCH/DEVELOPMENT

The present invention does not involve any form of federally sponsored research or development.

### BACKGROUND OF THE INVENTION

Vacuum-line plumbing systems have found numerous installations in building structures such as prisons and grocery stores, and in ships such as cruise-ships and navy ships. Vacuum is used to transport waste water from plumbing fixtures, such as sinks, toilets, showers etc to central collecting tanks for subsequent disposal.

In a vacuum-line system, each plumbing fixture is controlled by a system that comprises primarily of a controller and a plurality of pneumatically-activated devices, such as a pinch valve, a water valve etc. In a typical installation, the pinch valve is in fluid communication with the plumbing fixture to provide a fluid flow passageway for the removal of waste water. The output of the controller is fluidically connected to the pinch valve, thereby providing means to activate the pinch valve.

U.S. Pat. No. 6,311,718 illustrates a typical embodiment of a mechanical controller, and U.S. patent application Ser. No. 11/091,459 illustrates an embodiment of an electronic controller. For the purpose of this invention, both types of controller perform similar functions. During activation of the controller, vacuum is applied to the outlet port for a predetermined duration; after which, the controller is vented to the atmosphere. However, prior to the vacuum being completely vented, residual vacuum is often present within the controller. The means by which controllers are activated are fully disclosed in referenced documents.

A pneumatically-activated pinch valve typically embodies an elastic sleeve member that provides a fluid flow pathway between the plumbing fixture and the vacuum system. The sleeve member provides a fluid flow pathway in which waste water is transported by vacuum therethrough. The elastic sleeve member also functions as a barrier between the fluid pathway and the vacuum chamber that is used for activating the pinch valve.

U.S. Pat. Nos. 6,394,411 and 7,255,322 illustrate different embodiments of the elastic sleeve member. It is also known that despite numerous improvements in design, the elastic sleeve member is susceptible to failure. A common failure mode of the elastic member is a tear along the pinched line. The means and methods for activating and pinching the elastic sleeve member are disclosed in referenced documents.

If the elastic sleeve member fails, waste water from the fluid flow pathway is drawn through the vacuum chamber and into the controller. When exposed to waste matter, controllers often malfunction and require repair or a complete replacement. Additionally, contaminated hardware, such as tubing lines and check valves, also require replacement. Hence, the failure of one component, such as the elastic sleeve member in the pinch valve, results in the complete replacement of the control system, thereby resulting in a significantly higher expense to the user.

Additionally, a check valve is often installed on the inlet vacuum connection controller. The check valve prevents the reverse flow caused by residual vacuum inside the controller at the end of an activation cycle. Like the elastic sleeve member, the check valve is susceptible to failure. If the check valve fails to close, often due to clogging by airborne debris, residual vacuum inside the controller draws waste water from the fluid flow pathway into the controller. The consequences are similar to that described above.

### PRIOR ART

The use of shut-off devices and alarm systems for various fluid flow pathways are known in prior art. For example, U.S. Pat. No. 5,632,302 discloses an overflow protection shut-off device for use with a water heater. More particularly, the invention pertains to shutting off a supply of water to a water heater when a leak or an overflow condition occurs.

U.S. Pat. No. 6,442,955 relates to electrical condensate overflow safety switches. The activating/deactivating actions of the safety switch occur in the event a condensate drain line occludes in order to prevent or warn of potential drain pan overflow that could cause water damage to a building structure.

U.S. Pat. No. 7,191,606 generally relates to a drain trap alarm with an alarm sensor, specifically to a drain tray of the type used in HVAC condensate drain system.

U.S. Pat. No. 6,154,144 discloses an automatic shutoff overflow controller comprising a circuit that engages between a source of power and a water processing device. The controller, sensing an undesirable high water level in the water sensing device, shuts off the device and produces an audible warning that such condition exists.

Additionally, an embodiment of the water trap is used in vacuum-line systems found in medical institutions such as hospitals, clinics etc. In such installation, vacuum is often used for the evacuation of body fluids, particularly during and after surgical procedures. The fluids are collected in a canister and when full, the canisters are emptied or replaced by medical personnel. The water trap is used to interrupt fluid flow from entering the central vacuum in the event that collection canister overflows.

As represented in these examples, existing prior art systems have pertained to HVAC, water heater and the like. More particularly, none of the prior art pertains specifically to vacuum-line plumbing systems.

### BRIEF SUMMARY OF INVENTION

It is the object of this invention to prevent damage to controller due to water ingress, from either inlet or outlet fluid flow pathways.

A water trap apparatus generally comprising a jar that is removably threaded onto a cap, said cap having a smooth section, an undercut section and a threaded section, said cap having a first and a second threaded ports on side wall and on top center of said cap; said cap having an inner cavity and a circular protrusion extending into said cavity; an O-ring is disposed on said undercut section on said cap, said jar having an inner cavity, a threaded opening and a stepped interior surface adjacent to the rim, an elastomeric seal gasket having means for retention on said circular protrusion, said seal gasket having a smooth interior conical surface and an exterior wall extending beyond said threaded port on said cap, a float having a body with a smooth conical top surface and a plurality of fins extending radially from said body; said smooth conical surface is adapted to provide a sealing interface with said interior conical surface on said seal gasket, a first and a second barb fittings threaded into said first and second threaded ports on said cap and a hole transverses each said fittings to provide a fluid flow passageway therethrough.

### BRIEF DESCRIPTION OF THE DRAWINGS

FIG. 1 is a front view of water trap assembly in de-activation mode.

FIG. 2 is a front view of water trap assembly in activation mode.

FIG. 3 is the control system for a vacuum-line plumbing fixture in which a water trap assembly is installed at both inlet and outlet ports of a controller.

### DETAIL DESCRIPTION OF PREFERRED EMBODIMENT

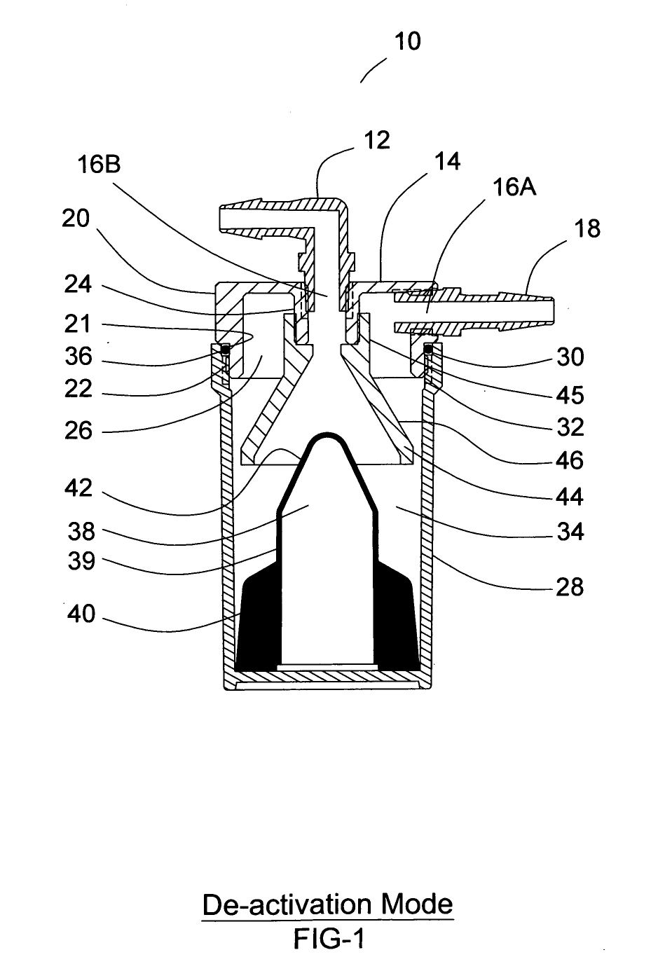

Referring now to the drawings, FIG. 1 shows a water trap assembly, generally indicated by reference 10. The assembly comprises of a jar 28, a cap 14, a float 38, a seal gasket 44 and a first and a second fittings, 12 and 18 respectively.

The jar has a cylindrical cavity 34, a threaded opening 32, and a stepped interior surface 30 adjacent to the rim. Preferably the jar is constructed of transparent or translucent thermoplastic in order to permit visual inspection of the contents therein.

The cap is cylindrical with a smooth section 20, an undercut section 21 and a threaded outer section 22. The pitch and diameter of the threads on the cap match that for the threads on the jar. On the smooth section of the cap are provided a first and a second threaded ports, 16A and 16B respectively. Preferably the first threaded port 16A is located on the side of the cap, and the second threaded port is located at the top center of the cap. The cap has an interior cavity 26 and opposite the first threaded port 16B is provided a circular protrusion 24 extending into cavity.

An O-ring 36 is disposed on the undercut section 21 on the cap. The cap is removably threaded onto the jar to provide a hermetic seal with the jar.

A first barb fitting 12 and a second barb fitting 18 are installed on the first and second threaded ports on the cap, respectively. Preferably, fitting 12 is shaped in 90-degree elbow and fitting 18 is straight. Additionally, the barbs on both inlet and outlet fittings are suited for connections to a soft tubing. A hole traverses each fitting thereby providing a fluid pathway therethrough.

A float 38 is disposed within the jar cavity. The float comprises of a body section 39 and a plurality of fins 40 that protrudes radially from the perimeter of the body. The body section has a tapered upper section 42 that has a smooth surface. The fins are sized such that the float moves along the central axis of the jar. The float is constructed of a material with specific gravity of less than 1. Further, it is beneficial to remove excess interior material from the float.

The seal gasket 44 has a straight section 45 with a smaller inner step, a conical section 46 and a hole that is concentrically disposed within the gasket from one end to the other. The inner tapered surface of the conical section is smooth and is suited to provide a sealing interface with the corresponding tapered surface on the float. The inner hole in the straight section is attachable to the circular protrusion on the cap by known means, for example friction fit or adhesive. A step on the inner hole functions as a stop on the protrusion. Additionally, the length of the conical section is adapted so that it is extends at least 0.5 inch beyond the inlet port 16A on the side of the cap in order to deflect the incoming fluid entering from the inlet port and preventing the fluid from directly entering the outlet port.

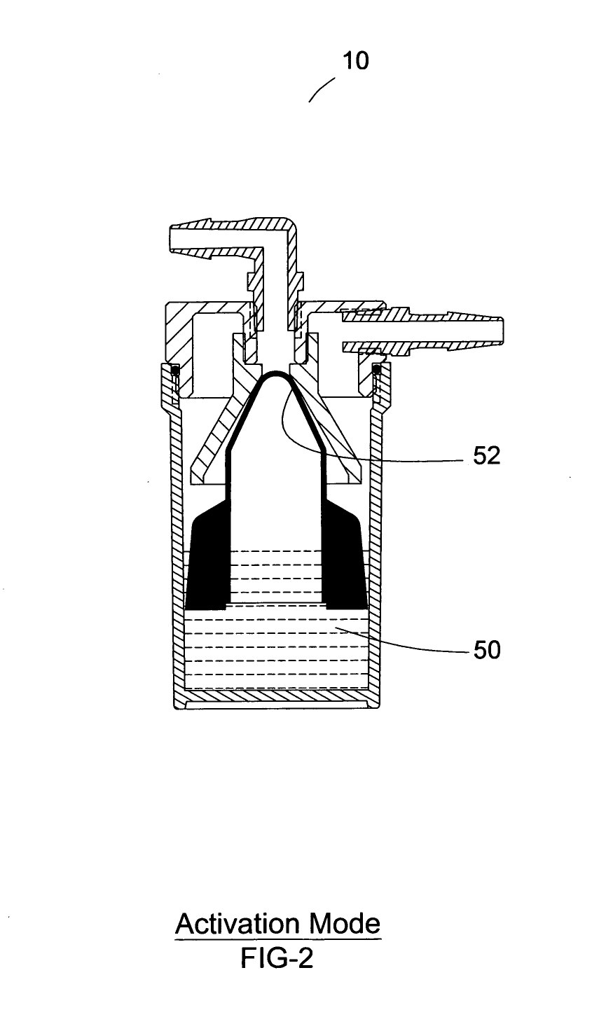

FIG. 1 shows the water trap assembly in the de-activation mode. The float is in the down position; the fluid flow pathway is un-interrupted between the inlet and the outlet fitting. Conversely, FIG. 2 shows the water trap assembly in the activation mode, in which water has been drawn into the jar. The accumulated water 50 lifts the float, thereby allowing the tapered surface on the float to engage the corresponding tapered surface on the sealing gasket and achieves a sealing interface 52 that interrupts fluid flow.

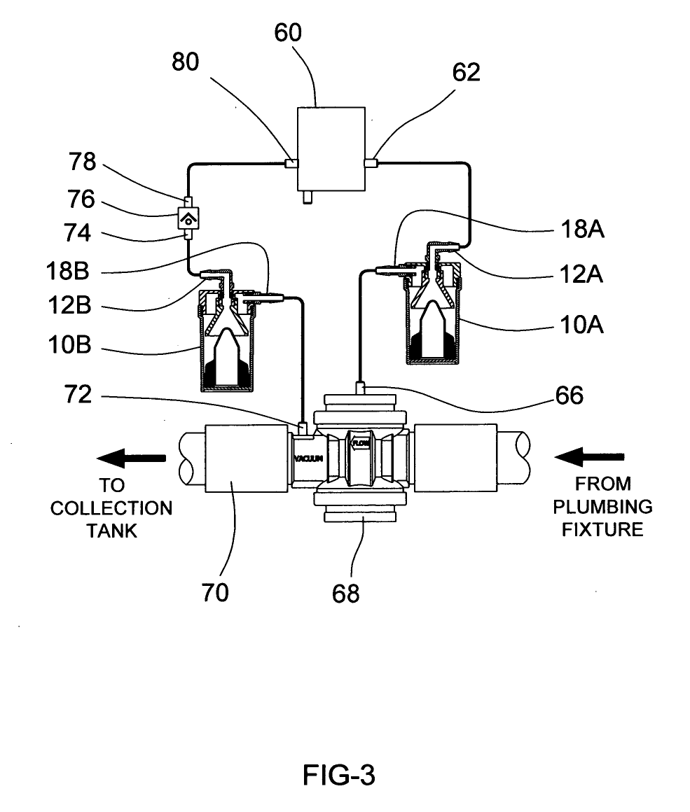

FIG. 3 shows the control system for a vacuum-line plumbing system with a first and a second mechanical water trap assemblies 10A and 10B respectively. The pneumatically-controlled device is a pinch valve assembly 68 that is equipped with port 66 for pneumatically activating the pinch valve.

The first water trap assembly 10A is fluidically interposed between the controller 60 and the pinch valve. Inlet fitting 18A on the water trap assembly is fluidically connected to port 66 on the pinch valve, and outlet fitting 12A is fluidically connected to the port 62 on the controller.

The second water trap assembly 10B is fluidically interposed between the vacuum line 70 and the check valve 76. Inlet fitting 18B on the water trap assembly is fluidically connected to port 72 on the vacuum line. The outlet fitting 12B is fluidically connected to the inlet port 74 on the check valve, and the outlet port 78 on the check valve is fluidically connected to port 80 on the controller.

The water trap assembly can be installed up-stream or down-stream of the check valve. As shown in FIG. 3, the water trap assembly is preferably installed upstream of the check valve (between pinch valve and check valve) so that the water trap renders protection to both check valve and controller.

What is claimed is:

1. A water trap assembly for vacuum-line plumbing systems comprising:
a jar that is removably threaded onto a cap; said cap having a smooth section, an undercut section and a threaded section; said cap having a first and a second threaded ports on side wall and top center of said cap respectively; said cap having an inner cavity and a circular protrusion extending into said cavity; said jar having an inner cavity, a threaded opening and a stepped interior surface adjacent to the rim;
an O-ring is disposed on said undercut section on said cap;
an elastomeric seal gasket that is attachable to said circular protrusion; said seal gasket having a smooth interior conical surface and an exterior wall extending beyond said threaded port on said cap;
a float having a body with a smooth conical top surface and a plurality of fins extending radially from said body; said smooth conical surface is adapted to provide a sealing interface with said interior conical surface on said seal gasket; said float is adapted to move concentrically within said jar;
a first and a second barb fittings threaded into said first and second threaded ports on said cap; a hole traverses each said fitting to provide a fluid flow passageway therethrough.

2. A water trap as defined in claim 1 wherein said float having a specific gravity less than 1 and interior material removed to reduce weight.

3. A water trap as defined in claim 1 wherein said jar is constructed of a transparent or translucent thermoplastic material.
